(19) United States
(12) Patent Application Publication
(10) Pub. No.: US 2008/0116761 A1
(43) Pub. Date: May 22, 2008

(54) Stator structures

(75) Inventors: Yung-Yu Lin, Taoyuan County (TW); Chun-Chieh Ni, Taoyuan County (TW)

Correspondence Address: BACON & THOMAS, PLLC, 625 SLATERS LANE, FOURTH FLOOR, ALEXANDRIA, VA, 22314, US

(73) Assignee: LIDASHI INDUSTRY CO., LTD, TAOYUAN (TW)

(21) Appl. No.: 11/797,784

(22) Filed: May 8, 2007

(30) Foreign Application Priority Data
Nov. 17, 2006 (TW) 95142713

(51) Int. Cl. H02K 1/16

(52) U.S. Cl. 310/257

(57) ABSTRACT

The stator structures including: a stator base has a plurality of stator slots and every stator slot is including two outside tunnels and an internal tunnel. The width of every outside tunnels is wider than the internal tunnel. Tow stator arrangements are provided on end of the stator base respectively. Every stator arrangement has a plurality of fixing portions and the fixing portions correspond to the outside tunnels. The thickness of every fixing portion is smaller or equal to the distance between the wall of every outside tunnel and the wall of every internal tunnel. Hence, every insulation plate occupies less space of said stator slot and the volume of every coil can be increased.

### BACKGROUND OF THE INVENTION

1. Field of the Invention

The present invention relates to a stator for motor and more particular to the stator structures.

2. Description of the Related Art

A motor includes a stator and a rotor conventionally and the stator mainly has a stator base. The stator base has an axial aperture at the center for receiving the rotor. There is a plurality of stator teeth radially extruding inward from the inside wall of the stator. An insulation stator slot is formed between two neighboring stator teeth for entwining coils. For accomplishing the assembling, the two ends of the stator base in opposition are mounted on a fixing portion of the stator arrangement by each insulation stator slot separately.

However, in those structures as aforesaid, the length of fixing portion of one stator arrangement is longer then the other. The stators combine with each other by way of using the longer fixing portion to pass through the stator slot and connecting with the shorter fixing portion. In order to pass through the stator slot, the fixing portion must be thick and strong enough to support the length. However, the fixing portion occupies more space and reduces the volume of coils if the fixing portion is too thick. The entwining job will be difficult. In addition, when the longer fixing portion passes through the stator slot and tries to connect with the shorter fixing portion, for a numbers of the fixing portions and the stator slots, it is not easy to aim those fixing portions at the other that place on the opposite side at the same time. The assembling work will be very inconvenient.

### SUMMARY OF THE INVENTION

The object of the present invention is to provide structures of a stator, which is easy to assemble and increases the volume of coils.

To achieve this object of the present invention, the stator structures including: a stator base, two stator arrangements and a plurality of insulation plates. The stator base has a plurality of stator teeth that are radial extruding inward from the inside wall. Said stator teeth are around the axis of said stator base and a stator slot is formed between two neighboring stator teeth. Every stator slot is including two outside tunnels and an internal tunnel. The width of every outside tunnel is wider than said internal tunnel. Every stator arrangement has a plurality of fixing portions respectively. Every fixing portion is placed in said outside tunnel. The thickness of every fixing portion is smaller or equal to the distance between the wall of the outside tunnel and the wall of the internal tunnel. Every stator arrangement fixes on end of said stator base respectively. Every insulation plate is placed respectively in the stator slots and covered on around every fixing portion and the walls of every internal tunnel.

Whereby the only thing needs to do is plugging the insulation plates into every insulation material when doing assembling. The assembling work is easy. Besides, the thickness of insulation plate is thin and covers on around the fixing portion and the walls of the internal tunnel. The insulation plates will not take too much space and the volume of coils can be increased.

### BRIEF DESCRIPTION OF THE DRAWINGS

FIG. 1 is a sectional view of the present invention with exploded parts;

FIG. 2 is a front view of the stator base of present invention;

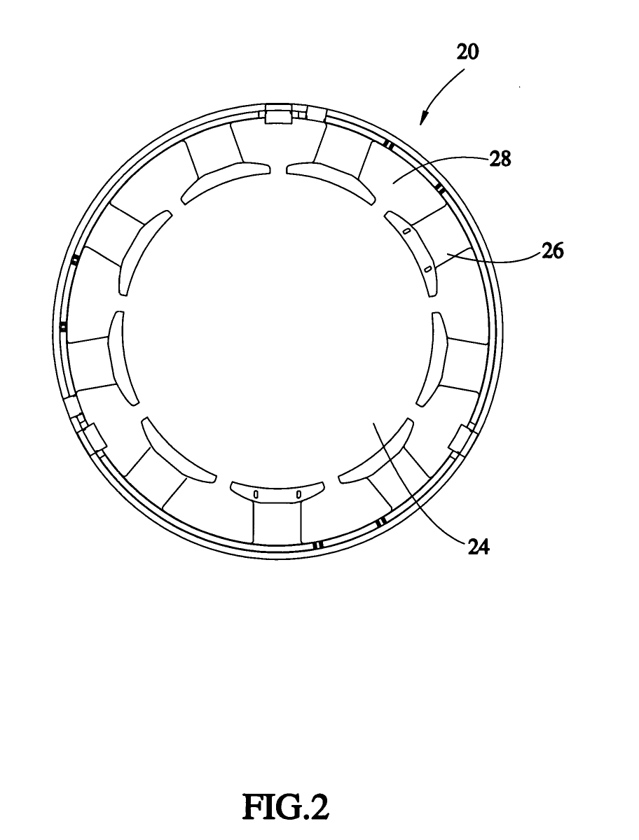

FIG. 3 is another section view of the present invention with exploded parts;

FIG. 4 is a front view of the stator arrangement of present invention;

FIG. 5 is the other sectional view of the present invention, which is shown the combination status of the stator base and the stator arrangement;

FIG. 6 is a sectional view of the combination of present invention;

### DETAILED DESCRIPTION OF THE INVENTION

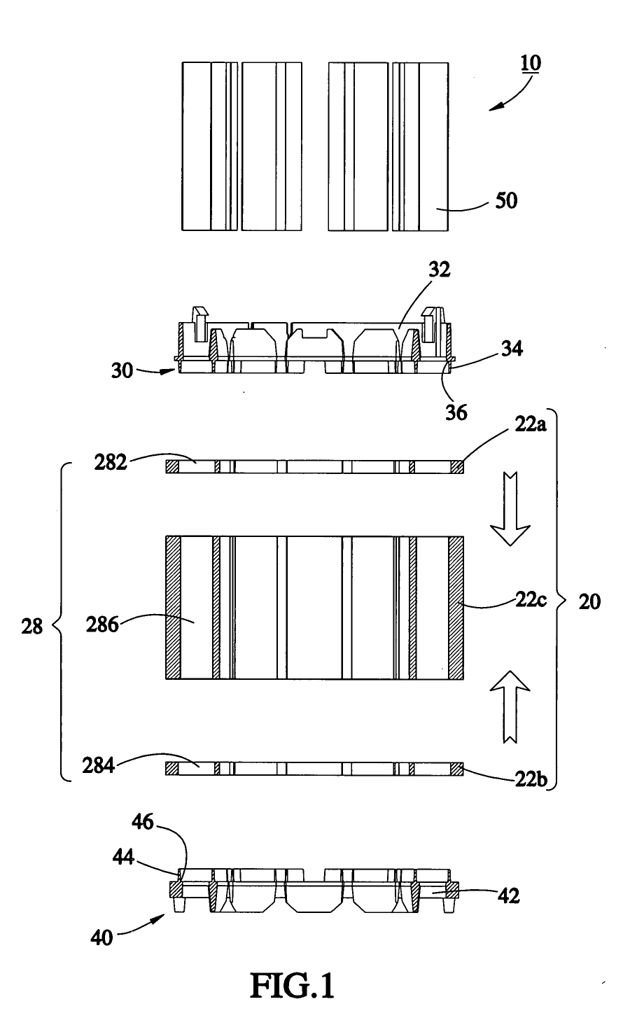

Referring to FIG. 1, the stator structures 10 of present invention including: a stator base 20, a first stator arrangement 30, a second stator arrangement 40 and a plurality of insulation plates 50.

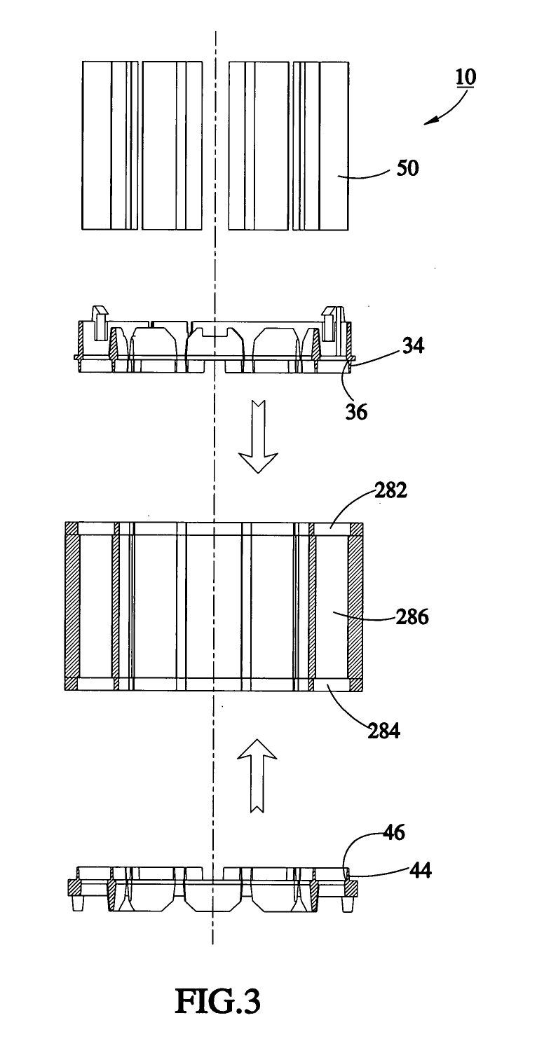

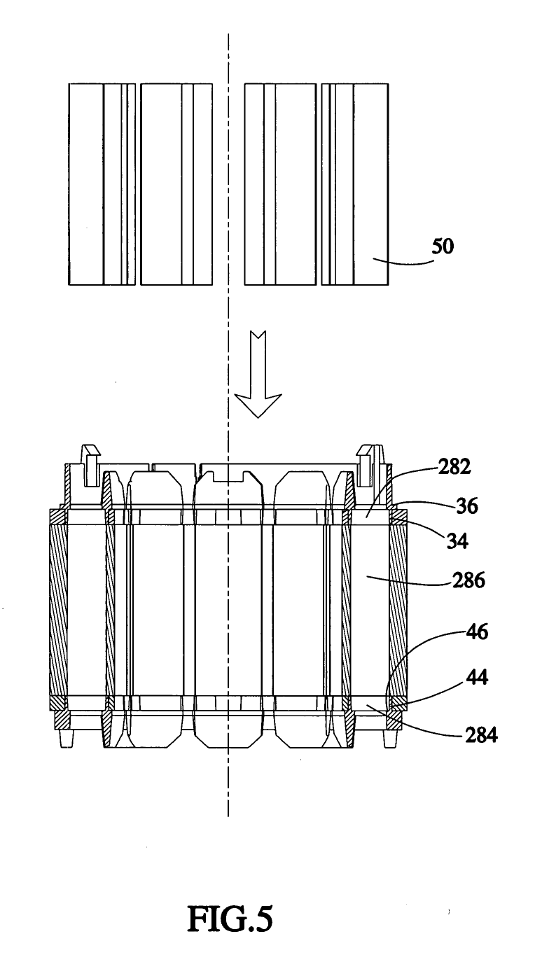

Referring to FIG. 5, said stator base is constituted by a plurality of silicon steel laminations 22a, 22b, 22c and an axial aperture is provided at the center for receiving a rotor. Every silicon steel lamination 22a, 22b, 22c of said stator base has a plurality of stator teeth 26 that are radial extruding inward from the inside wall. Those stator teeth 26 are around the axis of said stator base 20 in equidistance. A stator slot 28 that passes through said stator base 20 can be formed between two neighboring stator teeth 26 for receiving coils. Every stator slot 28 is including a first outside tunnel 282, a second outside tunnel 284 and an internal tunnel 286. Referring to FIG. 3, wherein said first outside tunnel 282 and said second outside tunnel 284 are provided on the outside silicon steel lamination 22a, 22b respectively. Said first outside tunnel 282 and said second outside tunnel 284 have same width. Said internal tunnel 286 is provided on those silicon steel laminations 22c, which pile up therein between said silicon steel lamination 22a and said silicon steel lamination 22b. The width of said internal tunnel 286 is narrower than said first outside tunnel 282 and said second outside tunnel 284.

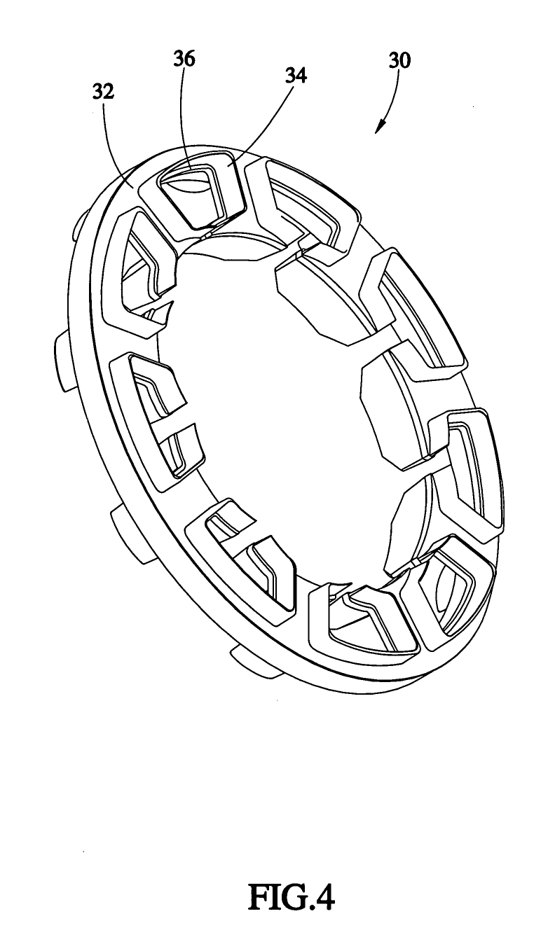

Referring to FIG. 4, said first stator arrangement 30 is including a first frame 32 and a plurality of first fixing portions 34, which extrude from said first frame 32. The location of each first fixing portion 34 is corresponding to every first outside tunnel 282 and the thickness of every first fixing portion 34 is equal to the distance between the wall of every first outside tunnel 282 and the wall of every internal tunnel 286. Besides, there is a first flange 36 provided on the inside wall of every first fixing portion 34. Every first fixing portion 34 is embedded in said first outside tunnel 282 and said first flanges 36 lean against one end of said stator base 20 for fixing said first stator arrangement 30 on one end of said stator base 20.

Said second stator arrangement 40 has the same shape with said first stator arrangement 30. Said second stator arrangement 40 is including a second frame 42 and a plurality of second fixing portions 44, which extrude from said second frame 42. The location of every second fixing portion 44 is corresponding to said second outside tunnel 284 and the thickness of every second fixing portion 44 is equal or smaller to the distance between the wall of every second outside tunnel 284 and the wall of every internal tunnel 286. In addition, there is a second flange 46 provided on the inside wall of every second fixing portion 44. Every second fixing portion 44 is embedded in said second outside tunnel 284 and said second flanges 46 lean against one end of said stator base 20 for fixing said second stator arrangement 40 on other end of said stator base 20.

Said insulation plate 50 is a slice that is made from plastic and is called insulation paper in popular name. Every insulation plate 50 can be bended to match the shape of every stator slot 28. The length of every insulation plates 50 is equal to every stator slot 28. Every insulation plate 50 is plugged into every stator slot 28 and covered on around every first fixing portion 34, the walls of every internal tunnel 286 and every second fixing portion 44. Every insulation plate 50 is limited in said stator slots 28 by every first flange 36 and every second flange 46 as shown in FIG. 5.

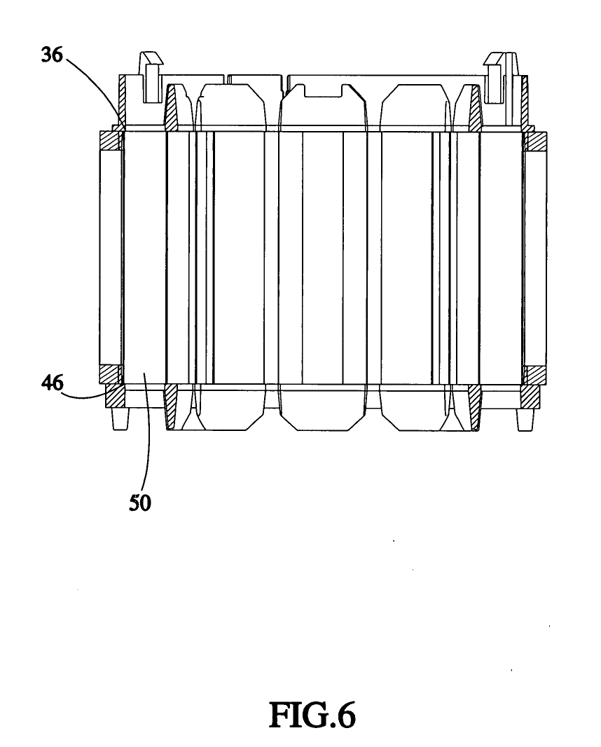

By those structures as aforesaid, at the time of assembling the present invention, the first fixing portions 34 of every first stator arrangement 30 and the second fixing portions 44 of every second stator arrangement 40 aim at the first outside tunnels 282 and the second outside tunnels 284 of said stator base 20 respectively, and then embed in every first outside tunnel 282 and every second outside tunnel 284. Said first flanges 36 and said second flanges 46 are against the end of said stator base separately as shown in FIG. 3. Due to the thickness of every first fixing portions 34 is equal to the distance between the wall of every first outside tunnel 282 and the wall of every internal tunnel 286 and the thickness of every second fixing portions 44 is equal to the distance between the wall of every second outside tunnel 284 and the wall of every internal tunnel 286, the width of every first outside tunnel 282 and every second outside tunnel 284 will be shrunk and is equal to every internal tunnel 286 when every first fixing portion 34 and every second fixing portion 44 embed in every first outside tunnel 282 and every second outside tunnel 284. Finally, every insulation plate 50 will be inserted from every first outside tunnel 282 as shown in FIG. 6. Because of the thickness of every said insulation plate 50 is quite thin and length of said insulation plate 50 is equal to said stator slots 28, that is to say, it is the length of said first outside tunnels 282, said second outside tunnels 284 and said internal tunnels 286 in sum, the two ends of every said insulation plate 50 will be fixed and limited by every first flange 36 and every second flange 46 when said insulation plate 50 is inserted into every stator slot 28. Every insulation plate 50 paste up on around every first fixing portion 34, the walls of every internal tunnel 286 and every second fixing portion 44 and occupy less space of said stator slots 28.

By using the design of the insulation plate, the structures of stator of the present invention not only can be assembled easily but also occupy less space of said stator slot. The coils occupy the most space of the stator slot and increase the volume.

What is claimed is:

1. Stator structures including:
a stator base having a plurality of stator teeth that are radial extruding inward from the inside wall; said stator teeth being around the axis of said stator base and a stator slot being formed between two neighboring stator teeth; every stator slot being including two outside tunnels and an internal tunnel; the internal tunnel being placed between said two outside tunnels; the width of every said outside tunnels being wider than said internal tunnel;
tow stator arrangements having a plurality of fixing portions separately and the fixing portions corresponding to the outside tunnels; the thickness of the fixing portions being smaller or equal to the distance between the wall of the outside tunnel and the wall of the internal tunnel, and
a plurality of insulation plates being placed respectively in the stator slots and covering on around every fixing portion and the walls of every internal tunnel.

2. The stator as claimed in claim 1, wherein the stator base is constituted by a plurality of silicon steel laminations and every said outside tunnels of the stator slot is provided on every outside silicon steel lamination, and said internal tunnels are provided on those silicon steel laminations, which pile up therein between said two outside silicon steel laminations.

3. The stator as claimed in claim 2, wherein flanges are provided on every stator arrangement respectively; every flange extrudes inward from the inside wall of every fixing portion and is against the end of said stator base respectively.
